(19) United States
(12) Patent Application Publication
(10) Pub. No.: US 2020/0294017 A1
(43) Pub. Date: Sep. 17, 2020

(54) SCALABLE DISTRIBUTED DELIVERY STATIONS

(71) Applicant: Go Plus Holdings Pte Ltd., Singapore (SG)

(72) Inventors: Erik Christian Anderson, Mill Valley, CA (US); Timothy Mathew Kobe, Singapore (SG); Pierre Habib, Singapore (SG); Massimiliano Terio, Singapore (SG)

(73) Assignee: Go Plus Holdings Pte Ltd., Singapore (SG)

(21) Appl. No.: 16/816,339

(22) Filed: Mar. 12, 2020

Related U.S. Application Data
(60) Provisional application No. 62/818,243, filed on Mar. 14, 2019.

(51) Int. Cl. G06Q 20/18; G06Q 10/08; B25J 9/04

(52) U.S. Cl. CPC G06Q 20/18; B25J 9/042; G06Q 10/0832; G06Q 10/0836

(57) ABSTRACT

A kiosk for automatic item delivery and receipt. The kiosk including an enclosure including at least one shelving unit and at least one automatic robot, the at least one automatic robot configured and arranged to transport the item; an electronic interface configured and arranged to allow a user to input data pertaining to the item; and a secured opening in the enclosure to allow access, by the item, to or from the enclosure.

### CROSS REFERENCE TO RELATED APPLICATIONS

This application is related to and claims priority from earlier filed provisional patent application No. 62/818,243 filed on Mar. 14, 2019, entitled “SCALABLE DISTRIBUTED DELIVERY STATIONS,” hereby incorporated by reference in its entirety.

### BACKGROUND OF THE INVENTION

The present disclosure relates to a system and method of scaling a system of a distributed network of customer facing automated kiosks.

Currently, there are a small number of vending machine type devices which can provide automatic service for customers wishing to purchase items. These systems are often unidirectional, meaning they are able to sell items to customers, but are unable to receive items, such as a package, from a customer. Moreover, the existing technology often suffers from limited sizing and are not integrated into existing architecture and infrastructure. As such, existing vending machines are seen as eyesores and add-ons to existing buildings.

For the foregoing reasons, there is a need for a system and method which provide automatic service stations which can be directly integrated into existing architecture, or integrated into new construction, which provide an adequate number of customer interfaces which can distribute and receive items to/from a customer without the need for a human clerk.

### SUMMARY OF THE INVENTION

The instant system seeks to remedy many of the above noted deficiencies in the prior art by determining the proper configuration needed for a given location as a function of a number of variables and to provide a system and method for bi-directional commerce to allow a customer to purchase and drop off items from the instant kiosks.

In some embodiments, the individual kiosks are intended to work as a distributed network of customer facing package pick up and drop off locations. As the system scales up, the system can determine the optimal sizing of a given kiosk based on traffic, demand, and other variables to ensure that an appropriate presence can be assured. For example, the instant system can work well in low traffic areas such as neighborhoods and rural communities; in cities, a solution to increased demand might be in a “corral” (configuration of multiple machines); or in higher density areas a storefront can be occupied by a “plug in” solution. In some embodiments, the kiosk can include a customer facing façade which can include multiple kiosk interfaces (e.g., 4×, 8×, 12×, etc. depending on width) with one or more robots in a secure interior to transport the packages to and from customers.

Moreover, the customer interface can include a number of features which enhance the usability of the kiosk. In some embodiments, the kiosks can include scales, scanners, cameras, and other sensors to determine the size, weight, and condition of a package during receipt of the package from a customer. Further, the system may include a printer, or other output device, which can output a shipping, or return, label on the received package.

Other benefits and objectives of the instant disclosure can be understood in view of the following detailed description, drawings, and claims.

### BRIEF DESCRIPTION OF THE DRAWING FIGURES

The novel features that are characteristic of the present disclosure are set forth in the appended claims. However, the disclosure's preferred embodiments, together with further objects and attendant advantages, will be best understood by reference to the following detailed description taken in connection with the accompanying drawings in which:

FIG. 1 shows the basic components of a first embodiment of the exemplary kiosk system;

FIG. 2 shows a perspective view of the kiosk system of FIG. 1;

FIG. 3 shows a perspective view of an alternate configuration of a kiosk system with kiosk of FIG. 1;

FIG. 4 shows a plan view of an interior of an exemplary kiosk;

FIG. 5 shows a plan view of an interior of an alternative exemplary kiosk; and

FIG. 6 shows an elevation view of an exemplary implementation of the instant kiosk system.

### DESCRIPTION OF THE INVENTION

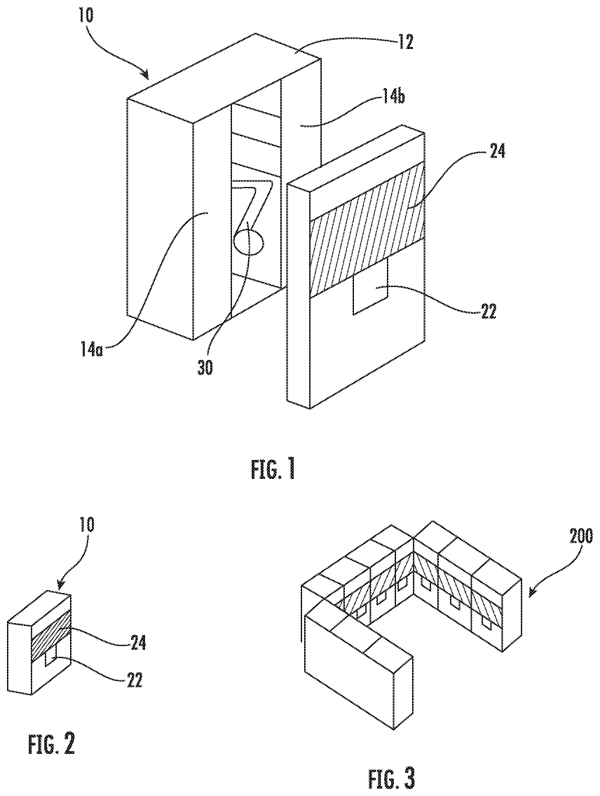

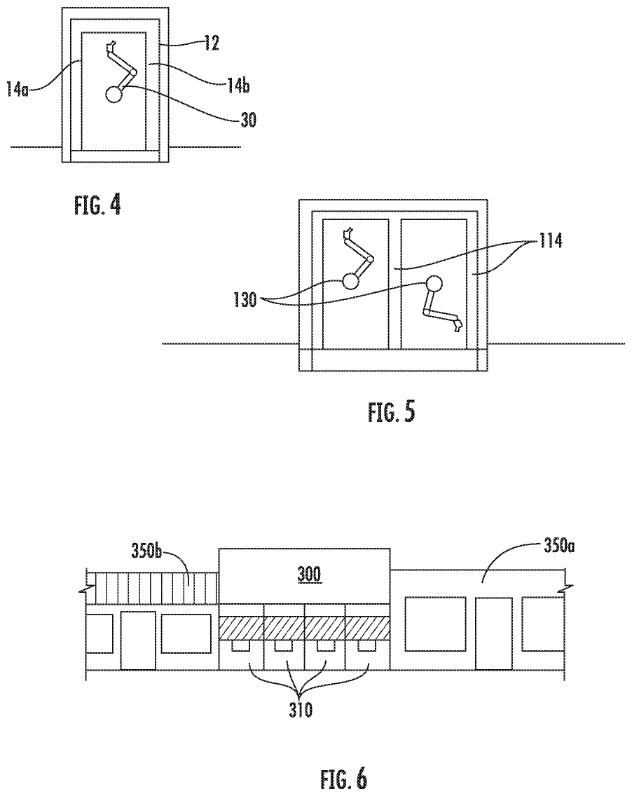

As stated above, currently there are vending machines and there are bricks and mortar retail shops; however, there are no solutions that address the scale and technology between the two. The instant system bridges the gap between the scale of a brick and mortar retail shop and vending machines by providing traditional retail sized automated kiosks which obviate the need for many, or any, employees to interface with customers. In general, whether there is one or a plurality of kiosks, will include an enclosure 12 having one or a plurality of shelves 14a, 14b which can hold any number of items for sale, or packages received from customers for distribution through a logistics system. The items, or packages, can be moved from a secured opening 22 within a front enclosure 20, to the shelves 14a, 14b by at least one multi axis articulated robot 30, as are known in the art (e.g., cartesian robot, gantry robot, cylindrical robot, SCARA robot, articulated robot, parallel robot, and/or anthropomorphic robot). The robot can include any number of pressure sensors to ensure that packages are appropriately handled and locationing hardware to allow for automatic movement of the robots including distance sensors, encoders, BLUETOOTH LE, ultra-wideband sensors, etc. In some embodiments, the kiosk 10 may include a plurality of articulated robots 130, as shown in FIG. 5, or may only include a single robot 30, as shown in FIG. 1. In some embodiments, the robot(s) 30 may be movably mounted on a rail (not shown) which is disposed parallel to a front face of the at least one shelf 14a, 14b to provide an additional degree of freedom to allow the robot 30 to reach a larger area. While not shown, the enclosure 12 can include an additional opening, or door, to allow a stock person to enter and either restock the kiosk or remove received packages from the kiosk 10. As shown in FIG. 5, in some embodiments, a plurality of rows of shelves 114 can be distributed through the kiosk and a plurality of robots 130 can be employed, at least one in each row. It should be understood, that in general, one robot 30, 130 can be disposed between two shelves 14a, 14b, 114, such that the robot can reach the shelving on either side. In some embodiments, the robot arms may be configured to reach through one shelf to another shelf in an adjacent row. Additionally, or alternatively, more than one robot may be disposed between a set of shelves and may be able to pass each other, or may have a dedicated range of motion that does not overlap. Advantageously, the use of robots and shelving, as opposed to a warehouse and retail floor, the instant kiosk can provide for a more efficient usage of storage volume for received packages, or stock of items, to increase the profitability of the kiosk itself, as real estate costs are generally high.

Referring back to the front enclosure 20, the front face can include a screen, or electronic interface, 24 which can be the customer facing interface. The screen 24 can provide a listing of items for sale and a payment interface. The payment interface can include a contactless payment system, e.g. NFC. The screen 24 can be touch sensitive and, in instances where there are a plurality of kiosks being used, the multiple screens 24 can be used in concert to display a corral wide advertisement. Additionally, or alternatively, the screen 24 can provide an interface for the customer to enter details pertaining to a package to be dropped off, including the destination address, weight, or other characteristics. In some embodiments, the front enclosure can include electronic communication interfaces to transmit data to the enclosure 12 and the robot 30 to ensure proper function; to transmit data from the kiosk 10 to a central server; or to transmit data to and from a user's personal electronic device. Moreover, the secured opening 22 can be pivotally, or slidably, mounted to the front enclosure 20, to permit the secured opening, or door, 22 to be opened to allow an item to be moved from inside the kiosk 10, or moved into the kiosk 10. In some embodiments, the front enclosure 20 can be pivotally connected, like a conventional door, to the enclosure 12. Alternatively, the front enclosure 20 can be otherwise removably attached to the enclosure 12 by other known means.

In a situation where the kiosk 10 is operating as a receiving node for a logistics network, the kiosk can include a number of features and systems which can measure and record necessary information regarding the package. For example, the kiosk 10 can include a scale (not shown) to measure the weight of the package; a sensor (or camera) to measure the volume of the package; a scanner to scan a label if already disposed on the package; a gas sensor to determine harmful materials, an X-Y-Z delivery mechanism, or a printer to print a label, or print directly on the package, having the necessary information for the package to successfully be delivered. The aforementioned scanner and camera can additionally be used when a customer purchases an item to ensure that the proper item is being distributed for the correct order. Moreover, the kiosks can include WIFI or cellular antenna to communicate between each other and a central server. Additionally, or alternatively, the kiosk can include a security camera on the front enclosure 20 to ensure safety of the customer and the items located therein.

In an exemplary embodiment, a system of kiosks 10 can work as a distributed network of customer facing package pick up and drop off locations for products. As the system scales up, it may be advantageous to determine the correct sizing of the kiosk(s) to be installed. For example, a size filter can be employed to site identification to ensure that an appropriate presence can be assured. The size filter can be a function of the population within a given radius (representing a certain square footage). The given radius may be smaller for more population dense areas and may overlap with other kiosk radii. If the location for the kiosk is going in a low population dense area, the overall radius may be significantly larger. Further, the size filter can be a function of advertising targets as well. For example, the instant kiosk 10, as shown in FIGS. 1 and 2, can work well in low traffic areas such as neighborhoods and rural communities; in cities, a solution to increased demand might be in a U-shaped (or any shape) “corral” 200 (configuration of multiple machines 10); in higher density areas a storefront 300 can be occupied by a “plug in” solution of multiple kiosks 310, as shown in FIG. 6. The façade 300 can be multiple kiosks 310 (e.g. 4, 8, 12, or any number, depending on the width of the storefront) with one or more robots in the secure interior to transport the packages.

The present system allows for deploying an appropriate scaled touch points of automatic kiosk systems 10, 110, 310, particularly at architectural scale. By offering a scalable solution, the appropriately sized touch point kiosk can be offered in any location. According to the demand at any potential location, at least two factors can help determine the appropriate configuration of kiosks needed. For example, the two factors can include the number of customers anticipated at peak and off peak operations, and the anticipated number of packages both in bound and out bound. In some embodiments, the instant kiosks 10, 110, 310, can be used in conjunction with a package delivery bid system as disclosed in co-pending application TBD, entitled “PACKAGE DELIVERY BID SYSTEM AND METHOD,” attorney docket no. G079 P03614-US1, hereby incorporated by reference in its entirety. In such an application, users may wish to ship a package to a desired destination and use the instant kiosk and associated methods to bid out to a variety of package logistics companies to obtain the best price and delivery speed. The instant kiosks can function as a central receiving node for the logistics vendors. Additionally, or alternatively, data or information from third parties can be purchased or shared to determine customer demographic information to determine the likely volume of traffic. From this anticipated information, the square footage of kiosk can be determined.

In some embodiments, for example the kiosk of FIGS. 1 and 2, the kiosk may be dropped into place, in other larger configurations, like the kiosks of FIG. 6, can use a “plug-in”approach using pre-fabrication technology to build out the entire shop off site then deliver and install the components with minimal intervention to the existing architecture. This approach can greatly speed up the installation of new locations.

It will be appreciated by those skilled in the art that various changes and modifications can be made to the illustrated embodiments without departing from the spirit of the present disclosure. All such modifications and changes are intended to be covered by the appended claims.

What is claimed is:

1. A kiosk for automatic item delivery and receipt, the kiosk comprising,
an enclosure including at least one shelving unit and at least one automatic robot, the at least one automatic robot configured and arranged to transport the item;
an electronic interface configured and arranged to allow a user to input data pertaining to the item; and
a secured opening in the enclosure to allow access, by the item, to or from the enclosure.

2. The kiosk of claim 1, further comprising
at least one sensor configured to measure the weight, volume, or identifying information about the item.

3. The kiosk of claim 1, wherein the electronic interface is electrically connected to the at least one robot.

4. The kiosk of claim 1, further including at least one electronic communication interface configured and arranged to allow electronic communication between the kiosk and a central server.

5. The kiosk of claim 1, further comprising,
an additional secured opening.

6. The kiosk of claim 1, wherein the kiosk is disposed in a storefront façade.
